(19) United States
(12) Patent Application Publication
(10) Pub. No.: US 2022/0113155 A1
(43) Pub. Date: Apr. 14, 2022

(54) Method for Providing Position Data of at Least One Entrance to a Navigation Destination, Server Device for Carrying Out a Method of This Type, and Motor Vehicle

(71) Applicant: Volkswagen Aktiengesellschaft, Wolfsburg (DE)

(72) Inventors: Thorben GÜNZEL, Braunschweig (DE); Stephan MAX, Gifhorn (DE)

(73) Assignee: Volkswagen Aktiengesellschaft, Wolfsburg (DE)

(21) Appl. No.: 17/276,904

(22) PCT Filed: Sep. 9, 2019
(86) PCT No.: PCT/EP2019/073921

§ 371 Date: Mar. 17, 2021

(30) Foreign Application Priority Data
Sep. 19, 2018 (DE) 10 2018 122 992.5

(51) Int. Cl. G01C 21/36; G01C 21/34; G01C 21/00; G08G 1/052; G08G 1/056; G08G 1/01

(52) U.S. Cl. CPC G01C 21/3617; G01C 21/3492; G01C 21/3685; G08G 1/0112; G08G 1/052; G08G 1/056; G01C 21/3811

(57) ABSTRACT

The invention relates to a method for providing position data of at least one entrance to a navigation destination. The method comprises the following: receiving respective vehicle data from a plurality of vehicles by means of an external server device, the vehicle data characterizing the current state and/or the environment of the vehicle in question; checking if, for the navigation destination, position data of at least one entrance to the navigation destination are known; if this is not the case: determining the position data by means of evaluation of the vehicle data that were provided by vehicles when said vehicles stopped in the area of the navigation destination, and by means of map data associated with the navigation destination; associating the determined position data with the navigation destination such that the navigation system determines a driving route over the entrance to the navigation destination when the navigation destination is selected.

### CROSS-REFERENCE TO RELATED APPLICATIONS

This application claims priority to German Patent Application No. DE 10 2018 122 992.5, filed on Sep. 19, 2018 with the German Patent and Trademark Office. The contents of the aforesaid Patent Application are incorporated herein for all purposes.

### TECHNICAL FIELD

The invention relates to a method for providing position data of at least one entrance to a navigation destination for a navigation system used in a motor vehicle, to a server device, which is configured to perform such a method, as well as to a motor vehicle with a navigation system or an interface for a navigation system.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Often, motor vehicles comprise navigation systems, by which a user can select a navigation destination and cause a driving route to this navigation destination to be displayed to him. Such navigation systems can partially access additional information to the routing.

However, if a user of a motor vehicle allows himself to be guided to a desired navigation destination with the aid of a navigation system, possibly, he cannot assume that a final position of the concerned driving route to this navigation destination has been optimally and reasonably ascertained, respectively.

### SUMMARY

An object exists to provide a solution, which allows to a navigation system to ascertain a particularly reasonable final position of a driving route to a navigation destination.

The object is solved by the subject matter of the independent claims. Embodiments of the invention are discussed in the dependent claims and the following description.

The details of one or more embodiments are set forth in the accompanying drawings and the description below. Other features will be apparent from the description, drawings, and from the claims.

### BRIEF DESCRIPTION OF THE DRAWINGS

FIG. 1 shows a schematic representation of an embodiment of a motor vehicle, which is guided to a navigation destination by a navigation system; and

FIG. 2 shows, in schematic representation, a signal flow graph of an embodiment of a method for providing position data of at least one entrance to a navigation destination for a navigation system used in a motor vehicle.

### DESCRIPTION

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

According to a first exemplary aspect, a method for providing position data of at least one entrance to a navigation destination for a navigation system used in a motor vehicle comprises the following steps: first, respective vehicle data is received by an external server device from multiple vehicles, wherein the vehicle data has a current state of the respective vehicle and/or an environment of the respective vehicle. In a first step, thus, the external server device collects data from the multiple vehicles, so-called swarm data. The external server device was for example a server device provided by a service enterprise or a server device provided by a vehicle manufacturer. The respective vehicle data provided for this external server device contains information about the current situation, in which the respective vehicle is, that is about the state thereof and/or the environment of the respective vehicle. Therein, the vehicle data may for example contain information about a current position of the respective vehicle. Alternatively or additionally thereto, environmental captures, which are captured by sensor units of the respective vehicle, and thus characterize the environment of the respective vehicle, may for example be received by the server device.

In a further step of the method, it is examined if position data of at least one entrance to the navigation destination is known regarding the navigation destination. For example, if a user of the motor vehicle, which comprises a vehicle's own navigation system, selects a navigation destination in this navigation system, it is first checked if position data of at least one entrance to this navigation destination is known for this navigation destination. This position data is for example corresponding coordinates, which for example describe the location of an entrance gate, an access road or a turning from the road to the navigation destination. The navigation destination itself may for example be an address or a special destination recorded in the navigation system like a point of interest or a shopping center.

In particular with a navigation destination, which is located between multiple roads or is located on larger premises and extends over a larger area, respectively, than it is usual for example for private homes or business houses, namely, position data of an entrance to the navigation destination is often not present in the navigation system. Thus, this check may for example occur after selecting a navigation destination in the navigation system of the motor vehicle. Within the scope of the check, herein, an inquiry may also be communicated to the external server device, which inquires if position data of at least one entrance to the navigation destination is known to the external server device. Alternatively or additionally thereto, the external server device may check if position data of at least one entrance to a possible navigation destination is known regarding this navigation destination, independently of an inquiry of a navigation system, and thereupon perform the further method steps.

If position data of the at least one entrance is not known regarding the navigation destination, the position data of the at least one entrance to the navigation destination is determined by means of evaluation of the vehicle data, which has been provided by those vehicles, when they have stayed in the environment of the navigation destination, as well as by means of map data associated with the navigation destination. Thus, if it is ascertained that for example to a certain shopping center, position data of the entrance to this shopping center is not known, it is resorted to the received vehicle data to determine position data of at least one entrance to the shopping center. However, herein, it is only resorted to the vehicle data, which has been communicated by vehicles, which have stayed in the environment of the shopping center and have communicated data to the server device during their stay in the environment of the shopping center. In determining the position data of the at least one entrance to the shopping center, it is additionally taken into account, where this shopping center is located. That means, it is resorted to the map data associated with the navigation destination, which is recorded in the external server device, to determine the position data of the at least one entrance to this navigation destination based on the vehicle data.

Thereupon, the determined position data of the at least one entrance to the navigation destination is associated with the navigation destination such that the navigation system ascertains a driving route up to the at least one entrance of the navigation destination upon selection of the navigation destination. Thus, after the position data of the entrance to the shopping center has for example been determined, an association of the position data determined therein with this navigation destination, that is for example with the special destination, which is related to the shopping center, occur. Thereupon, this data is provided to the navigation system of the motor vehicle. This provision may for example occur with the aid of an update for the navigation system.

This update package is provided by the server device and may for example be downloaded by a user of the motor vehicle and activated and installed, respectively, in the navigation system. Alternatively or additionally thereto, it is possible that the position data, associated with the navigation destination, of the at least one entrance to the navigation destination is stored on the external server device on demand. As soon as the navigation system of the motor vehicle communicates a corresponding inquiry for the position data of an entrance to a navigation destination to the sever device, the current position data of the at least one entrance to the navigation destination is thereupon communicated to the corresponding navigation system of the motor vehicle. Thereupon, the position data of the at least one entrance to the navigation destination is recorded in the navigation system such that a driving route to the selected navigation destination leads to the navigation destination via the at least one entrance. Alternatively or additionally thereto, the position data of the at least one entrance to the navigation destination may be recorded and selected as a destination position of a driving route in the navigation system.

The method according to the present exemplary aspect is based on the realization that the user of the motor vehicle often allows himself to be guided to a location, which is unknown to him heretofore, with the aid of a navigation system. In particular with special destinations, such as for example points of interest, shopping centers or airports, which often extend over a large terrain, the destination guidance of the navigation system to this special destination may terminate at any point on the terrain of the special destination and does not directly guide the motor vehicle to an entrance to the special destination. As a result of lack of local knowledge of the user of the motor vehicle, in such a situation, it is only possible for the user to find the corresponding entrance to the special destination with additional time expenditure and optionally under stress. In addition, it is possible that a navigation destination for example adjoins to two roads, the roads A and B. However, the entrance to the navigation destination is only accessible via the road A, whereas the exit leads onto road B. The entrance and exit of the navigation destination are indicated with corresponding signs on site. However, the destination guidance of the navigation system to this navigation destination could be terminated at the exit, that is on the road B, or else at any point therebetween, such that only a driver unfamiliar with the place easily reaches himself the entrance to the navigation destination as a result. However, this results in disappointments of the user of the motor vehicle as well as also in an avoidable time loss by searching for the entrance to the navigation destination. Analogously thereto, it may be the case in leaving the navigation destination that the navigation system first does not guide the user directly to the exit from the navigation destination with insufficient signage.

With the method according to the present exemplary aspect, it is now possible that based on respective vehicle data for example continuously captured during a travel of multiple vehicles, which is communicated to an external server device, the server device determines at least one entrance to a navigation destination. Thereby, it is allowed that the user of a motor vehicle may access the position data, associated with the navigation destination, of the entrance to the navigation destination, determined within the scope of the method, via the navigation system such that he may be directly guided to the entrance to a navigation destination and thus to the navigation destination itself via the entrance to the navigation destination with the aid of the navigation system.

Hereby, the search for an entrance to the navigation destination selected by the user possibly time consuming as well as associated with stress is omitted, which otherwise would occur with lack of position data of the entrance to the navigation destination in particular with users unfamiliar with the place. Thus, the approach to navigation destinations is very comfortably configured for the user of the motor vehicle with this method. In addition, fragmentary information of map data may be completed and updated with the method since the position data of an entrance to a navigation destination for example may be repeatedly determined in preset time intervals.

In some embodiments, it is provided that a respective vehicle position as well as respective motion data including a speed and/or a steering angle of the respective vehicle is provided by the multiple vehicles and received by the server device as the respective vehicle data. Thus, for example GPS position data describing the respective current vehicle position of the vehicles may be received by the server device as the vehicle data. Furthermore, information about a respective current speed as well as alternatively or additionally thereto about a current control of the steering of the respective vehicle is present to the external server device. For example, it may be taken from this type of vehicle data, which is often referred to as floating car data (FCD), if a vehicle is located in the environment of the navigation destination and how it has behaved there concerning its driving behavior. From the driving behavior there, such as for example turning described by the steering angle or deceleration and stopping of the vehicle captured based on the speed, it may be inferred if for example an entrance to a parking lot in front of a shopping center was traversed. Based on the respective vehicle positions as well as the respective motion data, thus, it may be estimated where the at least one entrance to the navigation destination could be located with low effort and a low amount of data.

In some embodiments, it is provided that at least one of the following data types is provided by the multiple vehicles and received by the server device as the respective vehicle data: operation data of a turn signal device of the respective vehicle; destination position data of the navigation system of the respective vehicle; a period of time of a respective stay of the respective vehicle at the navigation destination, during which the respective vehicle is turned off. Alternatively or additionally to the already mentioned vehicle positions and respective motion data of the respective vehicles, information to a turn signal operation of the turn signal device of the respective vehicle may be communicated to the server device. Based on these respective datasets, it may for example be recognized if the respective vehicle has turned from a road, wherefrom it may be inferred that this vehicle has for example turned onto an access road to a navigation destination or has for example traveled onto a customer parking lot of a shopping center. Alternatively or additionally thereto, the navigation destination of the respective vehicle selected in the navigation system is communicated to the server device. Based on the destination position data of the navigation system, that is based on the navigation destination selected in the navigation system, it may be inferred if the respective vehicle moves to the navigation destination, for which the position data of the at least one entrance to the navigation destination is to be determined, anyway. For example, if a further shop located next to the shopping center has been selected by a user of the respective vehicle instead of the shopping center according to the destination position data of the navigation system, it may be inferred that the data of this vehicle should not be used to determine the position data of the at least one entrance to the shopping center. Alternatively or additionally thereto, the time of stay of the respective vehicle at the location of the navigation destination may be taken into account. Based on this period of time, it may for example be estimated if the destination position of this vehicle is actually the shopping center or if this vehicle has for example stopped on a hidden path, which leads across the terrain of the shopping center, but does not include an actual entrance to the customer parking lot of the shopping center. For example, the period of time of the respective stay of the respective vehicle at the navigation destination corresponds to the period of time, which the respective vehicle was placed turned off at a location in the area of the navigation destination. Based on the mentioned data, the entrance to the navigation destination, which is actually an entrance to the navigation destination, may finally be identified with great probability.

Some embodiments provide that the multiple vehicles each capture the respective environment of the respective vehicle by means of a sensor device, wherein the environmental data captured therein is provided by the multiple vehicles and received by the server device as the respective vehicle data. Thus, the multiple vehicles for example comprise an ultrasonic sensor device, a front camera, lateral cameras, a rear camera, a front radar, front corner radars as well as corresponding evaluation units for recognizing objects in the environment of the respective vehicle. The environmental data captured by the individual sensors of the sensor device, that is for example the camera data of the front camera of the respective vehicle, is also communicated to the server device and received by it. Thereupon, this environmental data is taken into account in evaluating the vehicle data for determining the position data of the at least one entrance to the navigation destination. Based on the environmental data as the respective vehicle data, road signs, entrance markings or boundaries like walls or hedges, in the environment of the navigation destination may for example be recognized. Based on this data, it may for example be recognized if a first vehicle travels in front of a second vehicle, wherein the second vehicle captures environmental data and communicates it to the server device and the first vehicle for example turns to a parking lot in front of a shopping center and therefore decelerates its travel and activates the turn signal device such that an entrance to a navigation destination at the location, at which the first vehicle turns, may be inferred based on the environmental data of the second vehicle. Alternatively or additionally to the environmental data of the sensor device, it is conceivable that position data of the location is communicated to the server device, at which a preset payment process has been triggered, such as for example a payment process for a chargeable parking lot. Based on such data, the determination of the position data of the at least one entrance to the navigation destination may also be assisted and accurately configured. Based on the mentioned data, the entrance to the navigation destination, which is actually at least one entrance to the navigation destination, may finally be identified with great probability.

Some embodiments provide that it is ascertained based on the captured environmental data if a barrier is in the respective environment of the respective vehicle. This barrier is adapted to restrict the at least one entrance to the navigation destination such that the respective barrier position data of the ascertained barrier is provided by the multiple vehicles and received by the server device as the respective vehicle data. A particularly unique signal for the fact that a determined position is the position of an entrance to a navigation destination, is given by the presence of a barrier located there. Because barriers usually restrict areas restricted in access, such as for example chargeable parking lots in front of a special destination like a point of interest or a shopping center. A location, at which a barrier is arranged, therefore typically represents an entrance to a certain and spatially restricted location. Data, which is indicative of a presence of barriers, is thus particularly well suitable for determining the position data of the at least one entrance to a navigation destination since it very uniquely indicates the entrance to the navigation destination.

Some embodiments provide that the determined position data of the at least one entrance is associated with an address of the navigation destination recorded in the map data and/or with a special destination recorded in a database, which is selected as the navigation destination. The position data determined within the scope of the method according to the present aspect is thus associated with the navigation destination such that this position data is stored in the map data as the address of the navigation destination. Alternatively or additionally thereto, the determined position data is stored under a special destination in a database adapted thereto, which may be referred to as so-called point of interest database. Thereupon, the navigation destination is fixedly related to an entry in this database such that the position data of the at least one entrance to this special destination is typically selected as intermediate destination coordinates of the driving route to this navigation destination upon selection of this special destination in a navigation system. Thus, it becomes possible that corresponding data is finally provided for the navigation system, based on which the determined position data is provided for destination guidance to the navigation destination with the navigation system.

Some embodiments provide that it is checked if position data of at least one exit from the navigation destination is known regarding the navigation destination. Thus, instead of an entrance to the navigation destination, alternatively or additionally thereto, the method may be analogously performed for an exit from the navigation destination. If position data of the at least one exit is herein not known regarding the navigation destination, the position data of the at least one exit from the navigation destination is determined by means of evaluation of the vehicle data, which has been provided by those vehicles, when they have stayed in the environment of the navigation destination, as well as by means of map data associated with the navigation destination. Thereupon, the determined position data of the at least one exit of the navigation destination is associated with the navigation destination such that the navigation system ascertains a driving route upon a selection of a further navigation destination, according to which the motor vehicle leaves the navigation destination via the at least one exit. The position data of the at least one exit ascertained herein may for example correspond to the position data of the at least one entrance to the navigation destination. However, an exit from the special destination deviating from the entrance may also be provided, the position data of which is now determined analogously to the position data of the entrance and associated with the navigation destination.

According to the another aspect, a server device is additionally provided, which is configured to perform the above described method according to the first exemplary aspect. The exemplary embodiments presented in context of the method according to the first aspect and the benefits thereof correspondingly apply, if applicable, to the server device according to the present aspect. The server device comprises a processor device, which is configured to perform one or more embodiments of the explained method. Hereto, the processor device may comprise at least one microprocessor and/or at least one microcontroller. Furthermore, the processor device may comprise a program code, which is configured to perform the embodiment(s) of the explained method upon execution by the processor device. The program code may be stored in a data storage of the processor device.

According to the yet another aspect, a motor vehicle with a navigation system or an interface for a navigation system is additionally provided. This motor vehicle is adapted to communicate vehicle data to an external server device, as it was described above. Alternatively or additionally thereto, the motor vehicle is adapted to receive position data of at least one entrance associated with a navigation destination from the external server device, as it was described above. The exemplary embodiments presented in context of the server device according to the preceding aspect as well as of the method according to the first aspect and the benefits thereof correspondingly apply, if applicable, to the motor vehicle according to the present aspect.

How a motor vehicle communicates vehicle data to the external server device and/or receives position data of the at least one entrance associated with the navigation destination from the external server device, may be manually activatable and executable by the user of the motor vehicle. In some embodiments, a data exchange process between the external server device and the motor vehicle, that is the motor vehicle provides vehicle data for the external server device and in return receives the position data of the entrance to the navigation destination ascertained based on the swarm data from the server device.

Both the motor vehicle and the multiple vehicles, which communicate respective vehicle data to the external server device, are exemplary a motor vehicle or vehicles, which are adapted for at least partially autonomously and in particular for fully autonomously driving. The position data, associated with the navigation destination, of the at least one entrance to the navigation destination is provided to the navigation device of the motor vehicle, which is adapted for at least partially autonomously and in particular for fully autonomously driving, such that the navigation system may ascertain a driving route via the at least one entrance up to the navigation destination upon selection of the navigation destination. Thus, the position data of the at least one entrance may be used by a partially or fully autonomous driving function of the motor vehicle for determining the driving routes as well as for path planning.

Furthermore, the position data of the at least one entrance may be recorded in a corresponding database of a service provider, for example a provider of chargeable parking on a parking lot of a special destination. As soon as it is recognized based on the current vehicle position, that is based on the vehicle data of a vehicle, that this vehicle is located at the entrance to the parking lot, a payment process for a use of chargeable parking on the parking lot may for example be activated. The position data of the entrance ascertained with the method according to the present aspect may thus be used to define the location of the access to the area of the chargeable service provider.

Reference will now be made to the drawings in which the various elements of embodiments will be given numerical designations and in which further embodiments will be discussed.

In the exemplary embodiments, the described components of the embodiments each represent individual features that are to be considered independent of one another, in the combination as shown or described, and in combinations other than shown or described. In addition, the described embodiments can also be supplemented by features of the invention other than those described.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

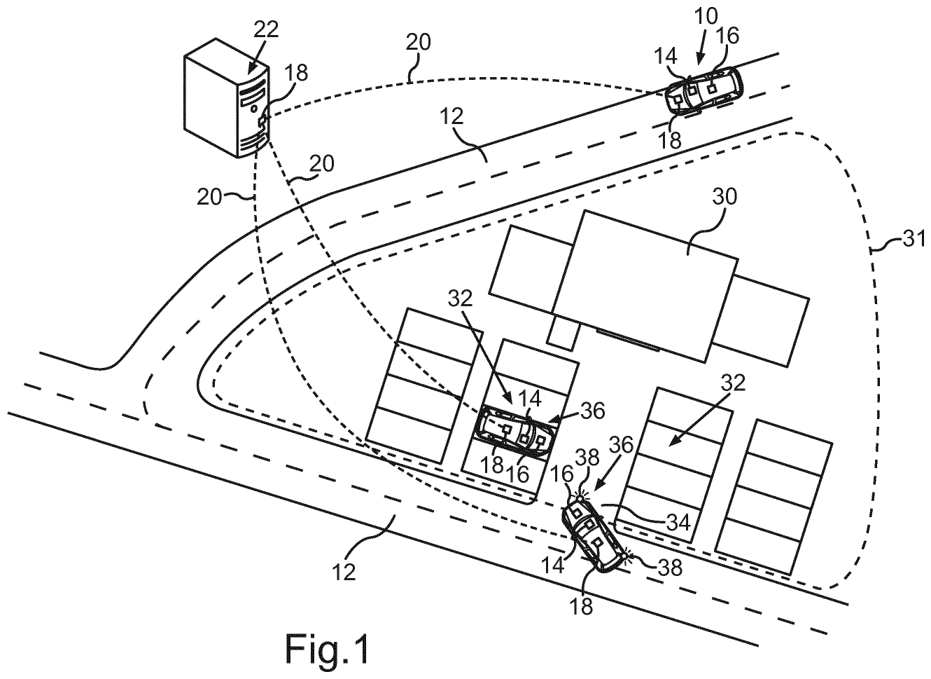

In FIG. 1, a motor vehicle 10 is outlined, which is driving on a road 12. The motor vehicle 10 includes a navigation system 14, a sensor device 16 as well as a communication device 18. Alternatively to the vehicle's own navigation system 14, the motor vehicle 10 may only comprise an interface for a navigation system 14, such that, for example with a mobile phone of a user of the motor vehicle 10, a navigation destination 30 may be selected by the user of the motor vehicle 10, to which the motor vehicle 10 is thereupon guided with the aid of the mobile phone.

The communication device 18 of the motor vehicle 10 is connected to the communication device 18 of an external server device 22 via a communication link 20.

In the navigation system 14 of the motor vehicle 10, a shopping center 30 has been selected by the user of the motor vehicle 10 as the navigation destination 30. The shopping center 30 is on a terrain 31, which is located between two roads 12. In addition, the shopping center 30 has a customer parking lot 32 as well as an entrance 34 to the customer parking lot 32.

In addition, two further vehicles 36 are located in the environment of the shopping center 30. The one of these vehicles 36 is on one of the parking spaces of the customer parking lot 32 and the other vehicle 36 is just turning from the road 12 to the customer parking lot 32 through the entrance 34. Due to this turning, a turn signal device 38 of the vehicle 36 is activated. The two vehicles 36 also each comprise a communication link 20 between the respective communication device 18 of the respective vehicle 36 as well as the external server device 22.

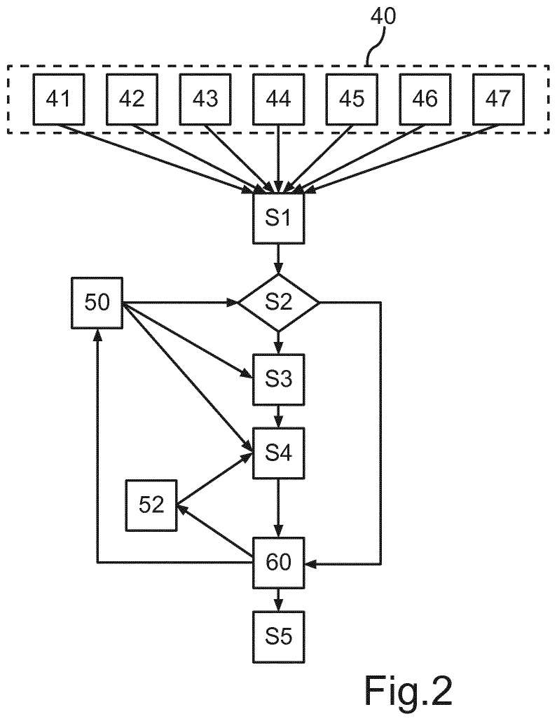

Now, the external server device 22 is adapted to perform the method outlined in FIG. 2. Within the scope of this method, the external server device 22 first receives respective vehicle data 40 from multiple vehicles 36, for example the two vehicles 36, which are outlined in FIG. 1, in a first method step S1, wherein the vehicle data 40 characterizes a current state of the respective vehicle 36 and/or an environment of the respective vehicle 36. The vehicle data 40 includes a respective vehicle position 41, that is for example GPS position data of the respective vehicles 36, as well as respective motion data 42, which includes a speed and/or a steering angle of the respective vehicle 36. Alternatively or additionally thereto, the vehicle data 40 includes operation data 43 of the turn signal device 38 of the respective vehicle 36, destination position data 44 of the navigation system 14 of the respective vehicle 36 and/or a period of time 45 of a respective stay of the respective vehicle 36 at the shopping center 30, during which the respective vehicle 36 is turned off. Alternatively or additionally thereto, the respective vehicles 36 capture respective environmental data 46 by means of their respective sensor device 16. This environmental data 46 is also received by the external server device 22 as the vehicle data 40. Based on the captured environmental data 46, it may for example be ascertained if a barrier is located in the respective environment of the respective vehicle 36, which is adapted to restrict the at least one entrance 34 to the navigation destination 30. Thereupon, the respective barrier position data 47 of the ascertained barrier is provided by the multiple vehicles 36 and received by the server device 22 as well or alternatively to the mentioned vehicle data 40.

In a next method step S2, it is checked if position data 60 of the at least one entrance 34 to the shopping center 30 is known regarding the shopping center 30. This method step S2 may either occur at any point of time in the external server device 22 or only be effected if the user of the motor vehicle 10 selects the shopping center 30 as the navigation destination 30 in the navigation system 14 of the motor vehicle 10, that is inquiries a driving route to the shopping center 30. Upon checking if position data 60 of at least one entrance 34 to the shopping center 30 is already known regarding the shopping center 30, map data 50 may additionally be taken into account, based on which the position of the shopping center 30 is recorded in the navigation system 14.

If position data 60 of the entrance 34 to the customer parking lot 32 is already known regarding the shopping center 30, the navigation system 14 may ascertain a driving route via the entrance 34 of the shopping center 30 up to the shopping center 30, as it is effected in the method step S5. However, if position data 60 of the entrance 34 of the shopping center 30 is not known regarding the shopping center 30, determining the position data 60 of at least one entrance 34 to the shopping center 30 is effected in the method step S3. This is effected by means of evaluation of the vehicle data 40 provided by those vehicles 36, which have stayed in the environment of the shopping center 30, that is for example based on the vehicle data 40 of the two vehicles 36 outlined in FIG. 1. In addition, the map data 50 associated with the shopping center 30 is taken into account in evaluating for determining the position data 60 in the method step S3. This map data 50 for example contains the coordinates of the terrain 31, on which the shopping center 30 is located.

In a next method step S4, the position data 60 of the entrance 34 determined in method step S3 is associated with the shopping center 30. Herein, both the map data 50 and entries in a database 52 are taken into account. For example, a special destination is recorded in the database 52, upon the selection of which the navigation system 14 of the motor vehicle 10 ascertains a driving route to the shopping center 30. Thus, the position data 60 of the entrance 34 of the shopping center 30 is provided by the method step S4 such that it may for example be transferred from the external sever device 22 to the motor vehicle 10 via the communication link 20 in the form of an update package for the navigation system 14. Alternatively or additionally thereto, the determined position data 60 may be stored on the external server device 22 for retrieval such that the position data 60 is provided for the navigation system 14 upon an inquiry of the navigation system 14 via the communication link 20.

With the aid of the position data 60 of the entrance 34 to the customer parking lot 32 of the shopping center 30, it may be allowed in the method step S5 that the navigation system 14 ascertains a driving route via the entrance 34 up to the shopping center 30 upon selection of the shopping center 30 by the user of the motor vehicle 10. The determined position data 60 of the entrance 34 is associated with an address of the shopping center 30 recorded in the map data 50 and/or with a special destination recorded in the database 52, which is referred to as shopping center 30, and stored in the map data 50 and/or the database 52.

It is to be noted that at least one entrance 34 for the shopping center 30 is determined and associated with the aid of the method outlined in FIG. 2. Alternatively or additionally thereto, at least one exit from the shopping center 30 may also be effected with the aid of an analogous procedure, that is with the aid of analogous method steps S1 to S5.

Overall, the example shows, how the position data 60 of the at least one entrance 34 of the navigation destination 30 may be determined and associated with it with the method for providing position data 60 of at least one entrance 34 to a navigation destination 30 for a navigation system 14 used in a motor vehicle 10. Herein, swarm data of multiple vehicles 36 is taken into account, which have already stayed in an environment of the navigation destination 30 and there have generated corresponding vehicle data 40 and communicated it to the external server device 22. The position data 60 obtained with the method may finally be used to update the map data 50 as well as the database 52 of special destinations such that the entrance 34 to the navigation destination 30 may be immediately approached with the navigation system 14 of the motor vehicle 10 in future travels.

### LIST OF REFERENCE NUMERALS

10 Motor vehicle

12 Road

14 Navigation system

16 Sensor device

18 Communication device

20 Communication link

22 Server device

30 Navigation destination/shopping center

31 Terrain

32 Customer parking lot

34 Entrance

36 Vehicle

38 Turn signal device

40 Vehicle data

41 Vehicle position

42 Motion data

43 Operation data

44 Destination position data

45 Period of time

46 Environmental data

47 Barrier position data

50 Map data

52 Database

60 Position data

S1 Method step

S2 Method step

S3 Method step

S4 Method step

S5 Method step

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1. A method for providing position data of at least one entrance to a navigation destination for a navigation system used in a motor vehicle, comprising the following steps:
receiving respective vehicle data from multiple vehicles by an external server device, wherein the vehicle data characterizes a current state of the respective vehicle and/or an environment of the respective vehicle;
determining if position data of at least one entrance to the navigation destination is known regarding the navigation destination;
if position data of the at least one entrance is not known regarding the navigation destination: determining the position data of the at least one entrance to the navigation destination by evaluation of the vehicle data, which was provided by at least one of the vehicles that was present in the environment of the navigation destination, as well as by fusing map data associated with the navigation destination; and
associating the determined position data of the at least one entrance with the navigation destination such that the navigation system ascertains a driving route via the at least one entrance up to the navigation destination upon selection of the navigation destination.

2. The method of claim 1, wherein
a respective vehicle position as well as respective motion data, which includes a speed and/or a steering angle of the respective vehicle, is provided by the multiple vehicles and received by the server device as the respective vehicle data.

3. The method of claim 1, wherein at least one of the following types of data is provided by the multiple vehicles and received by the server device as the respective vehicle data:
operation data of a turn signal device of the respective vehicle;
destination position data of the navigation system of the respective vehicle; and
a period of time of a respective stay of the respective vehicle at the navigation destination, during which the respective vehicle is turned off.

4. The method of claim 1, wherein the multiple vehicles each capture the respective environment of the respective vehicle using a sensor device, wherein the environmental data captured therewith are provided by the multiple vehicles and received by the server device as the respective vehicle data.

5. The method of claim 1, wherein it is ascertained based on the captured environmental data if a barrier is located in the respective environment of the respective vehicle, which is adapted to restrict the at least one entrance to the navigation destination, and the respective barrier position data of the ascertained barrier is provided by the multiple vehicles and received by the sever device as the respective vehicle data.

6. The method of claim 1, wherein the determined position data of the at least one entrance is associated with an address of the navigation destination recorded in the map data and/or with a special destination recorded in a database, which is selected as the navigation destination.

7. The method of claim 1, wherein it is determined if position data of at least one exit from the navigation destination is known regarding the navigation destination, and if position data of the at least one exit is not known regarding the navigation destination, the position data of the at least one exit from the navigation destination is determined by evaluation of the vehicle data, which has been provided by at least one of the vehicles that was present in the environment of the navigation destination, as well as by using map data associated with the navigation destination, and the determined position data of the at least one exit is associated with the navigation destination, such that the navigation system ascertains a driving route upon selection of a further navigation destination, according to which the motor vehicle leaves the navigation destination via the at least one exit.

8. A server device comprising a processor device, which is configured to perform a method according to claim 1.

9. A motor vehicle with a navigation system or an interface for a navigation system, wherein the motor vehicle is adapted to communicate vehicle data to an external server device according to claim 8.

10. The method of claim 2, wherein at least one of the following types of data is provided by the multiple vehicles and received by the server device as the respective vehicle data:
operation data of a turn signal device of the respective vehicle;
destination position data of the navigation system of the respective vehicle; and
a period of time of a respective stay of the respective vehicle at the navigation destination, during which the respective vehicle is turned off.

11. The method of claim 2, wherein the multiple vehicles each capture the respective environment of the respective vehicle using a sensor device, wherein the environmental data captured therewith are provided by the multiple vehicles and received by the server device as the respective vehicle data.

12. The method of claim 3, wherein the multiple vehicles each capture the respective environment of the respective vehicle using a sensor device, wherein the environmental data captured therewith are provided by the multiple vehicles and received by the server device as the respective vehicle data.

13. The method of claim 2, wherein it is ascertained based on the captured environmental data if a barrier is located in the respective environment of the respective vehicle, which is adapted to restrict the at least one entrance to the navigation destination, and the respective barrier position data of the ascertained barrier is provided by the multiple vehicles and received by the sever device as the respective vehicle data.

14. The method of claim 3, wherein it is ascertained based on the captured environmental data if a barrier is located in the respective environment of the respective vehicle, which is adapted to restrict the at least one entrance to the navigation destination, and the respective barrier position data of the ascertained barrier is provided by the multiple vehicles and received by the sever device as the respective vehicle data.

15. The method of claim 4, wherein it is ascertained based on the captured environmental data if a barrier is located in the respective environment of the respective vehicle, which is adapted to restrict the at least one entrance to the navigation destination, and the respective barrier position data of the ascertained barrier is provided by the multiple vehicles and received by the sever device as the respective vehicle data.

16. The method of claim 2, wherein the determined position data of the at least one entrance is associated with an address of the navigation destination recorded in the map data and/or with a special destination recorded in a database, which is selected as the navigation destination.

17. The method of claim 3, wherein the determined position data of the at least one entrance is associated with an address of the navigation destination recorded in the map data and/or with a special destination recorded in a database, which is selected as the navigation destination.

18. The method of claim 4, wherein the determined position data of the at least one entrance is associated with an address of the navigation destination recorded in the map data and/or with a special destination recorded in a database, which is selected as the navigation destination.

19. The method of claim 5, wherein the determined position data of the at least one entrance is associated with an address of the navigation destination recorded in the map data and/or with a special destination recorded in a database, which is selected as the navigation destination.

20. A motor vehicle with a navigation system or an interface for a navigation system, wherein the motor vehicle is adapted to receive position data of at least one entrance, which is associated with a navigation destination, from an external server device.
